(19) United States
(12) Patent Application Publication
(10) Pub. No.: US 2026/0240209 A1
(43) Pub. Date: Aug. 20, 2026

(54) TASTE MODIFIERS COMPRISING A MAILLARD REACTION PRODUCT

(71) Applicant: GIVAUDAN SA, VERNIER (CH)

(72) Inventors: Amy YAP, Cincinnati, OH (US); Cecil DUNCAN, Cincinnati, OH (US); Jenifer AUGELLI, Cranbury, NJ (US); Wendye PANZER, Cranbury, NJ (US)

(21) Appl. No.: 19/471,104

(22) PCT Filed: Apr. 29, 2024
(86) PCT No.: PCT/EP2024/061803

§ 371 Date: Sep. 30, 2025

Related U.S. Application Data
(60) Provisional application No. 63/464,042, filed on May 4, 2023.

(51) Int. Cl. A23L 27/21; A23J 3/16; A23J 3/22; A23L 19/00; A23L 27/00

(52) U.S. Cl. CPC A23L 27/215; A23J 3/16; A23J 3/227; A23L 19/00; A23L 27/84; A23L 27/86; A23L 27/88

(57) ABSTRACT

A taste-modifying composition comprising a Maillard reaction product of a proteinogenic amino acid and a reducing sugar which is effective in counteracting off-tastes imparted by at least one ingredient in a plant-based consumable when the Maillard reaction product is present in an amount of about 0.005% to about 5% in the consumable. Methods of masking an off-taste imparted by one or more ingredients in a plant-based consumable by addition of a Maillard reaction product to the consumable is also provided.

### TECHNICAL FIELD

The present disclosure relates to plant-based consumables, such as jackfruit (Artocarpus heterophyllus), the taste profiles of which may be modified by the addition of a Maillard reaction product.

### BACKGROUND

Plant-based consumables, such as food products and beverages, are a more sustainable and environmentally friendly option compared to animal products that require significant energy, land, and water to grow. However, the flavour of many plant-based consumables need improvement to gain greater acceptance from consumers. For example, consumables made from leguminous plants, such as soy or pea, display a flavor profile described as grassy, beany, green, earthy, nutty and/or bitter. In addition, while jackfruit (Artocarpus heterophyllus) has a suitable texture for use in meat analog products due to its stringy, meaty texture, it imparts undesirable off-tastes described as bitter, astringent, earthy and/or chalky. In many instances, the flavor quality of such consumables would be improved by diminishing or removing the off-tastes, while at the same time preserving or enhancing the contribution made to the overall flavor by the other flavor components. Accordingly, there is a need for plant-based consumables, in particular jackfruit, having an improved flavor profile with reduced or no off-tastes.

### SUMMARY

In one embodiment, a taste modifying composition comprising a Maillard reaction product of a proteinogenic amino acid and a reducing sugar which is effective in counteracting off-tastes imparted by at least one ingredient in a plant-based consumable when the Maillard reaction product is present in an amount of about 0.005% to about 5% in the consumable.

In another embodiment, a plant-based consumable includes at least one ingredient that imparts an off-taste to the plant-based consumable, and an off-taste masking and/or modifying agent comprising a Maillard reaction product of a proteinogenic amino acid and a reducing sugar, wherein the Maillard reaction product is present in the plant-based consumable in an amount of about 0.005 wt. % to about 5 wt. %.

In yet another embodiment, a method for modifying the taste of a plant-based consumable comprising: adding a Maillard reaction product of a proteinogenic amino acid and a reducing sugar to the plant-based consumable in an amount of about 0.005% to about 5%, which amount modifies or masks an off-taste imparted by at least one ingredient in the consumable.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The present disclosure relates to the surprising finding that unpleasant off-tastes imparted by one or more ingredients in plant-based consumables, in particular jackfruit, may be modified or the taste or taste perception may be improved by the inclusion of a Maillard reaction product of a proteinogenic amino acid and a reducing sugar in said consumables.

The present disclosure also relates to the surprising finding that a Maillard reaction product of a proteinogenic amino acid and a reducing sugar has an affinity to bind to non-animal proteins. According to the present disclosure, the Maillard reaction product has a higher affinity to non-animal proteins than the affinity of a flavorant to non-animal proteins. This results in a higher concentration of free flavorants (i.e., greater flavor release) in a particular plant-based consumable because the complex formed is Maillard reaction product/protein rather than flavorant/protein. Therefore, the invention provides in a first aspect a plant-based consumable comprising an amount of a Maillard reaction product of a proteinogenic amino acid and a reducing sugar sufficient to modify off-tastes imparted by one or more ingredients in said consumables.

### Maillard Reaction Product

The disclosed Maillard reaction product is formed by heating a mixture of precursor ingredients including a nitrogen source, such as amino nitrogen, and a carbohydrate source, such as a reducing sugar in an aqueous slurry. The Maillard reaction product may be obtained by non-enzymatic browning reactions of precursor ingredients comprising reducing sugars and amino functionalities (including amino acids, amides, ammonium, and ammonia) in the presence of heat. The reactive carbonyl group of the sugar interacts with the nucleophilic amino group of the amino acid. In certain embodiments, a Maillard reaction product is used interchangeably with the terms “process flavour” or “reaction flavour”. See for example Weerasinghe and Sucan in ACS Symposium Series, American Chemical Society, Chapter 1 “Process and Reaction Flavors: An Overview” at pages 1-23 (2005), the disclosure of which is incorporated herein by reference.

In addition to amino acids/amine sources (or their sources) and reducing sugars, slurries may also include lipids or fats, spices and protein sources, such as hydrolyzed vegetable proteins (HVPs) or yeast autolysates. In addition to these materials, the slurry may contain other materials that can modify taste or flavour, including sulphur sources, meat powders, and powdered broths or stocks.

In certain embodiments, the Maillard reaction product is obtained by heat processing together a protein nitrogen source and a carbohydrate source at a temperature between about 60° C. to about 180° C. In certain embodiments, the combination of carbohydrate source, nitrogen source and liquid phase is heated to a temperature of between about 60° C. to about 170° C., or between about 100° C. to about 140° C. According to certain embodiments, the heating is carried out for a period of about 0.1 to about 8 hours, or for a period of about 0.5 to about 7 hours, or for a period of about 1 to about 2 hours The reaction relies mainly on sugars and amino acids, but it can also contain other precursor ingredients including: autolyzed yeast extracts, hydrolyzed vegetable proteins, gelatin, vegetable extracts, enzyme treated proteins, and acids or bases to adjust the pH of the reaction. In certain embodiments, the Maillard reaction product may be obtained by heat processing together a proteinogenic amino acid, a reducing sugar, and a yeast extract at a temperature between about 60° C. to about 180° C.

The Maillard reaction product is an article of manufacture that is intended to be added to foods or beverages to modify or improve flavor in a food or beverage. In certain embodiments, the Maillard reaction product is essentially non-nutritional, that is, its substantial purpose is to enhance, modify or improve the flavor of food or beverages to which it is added, not to provide nutrition.

The Maillard reaction product may be in the form of a liquid or a solid, for example a powdered solid or paste. In certain embodiments, after cooking a slurry to form a Maillard reaction product in a first step, the slurry is dehydrated in a second step by spray drying or vacuum over drying. In certain embodiments, after preparing the Maillard reaction product in a slurry, the slurry is transferred to drying trays and the trays are inserted into a vacuum oven, whereupon the water is evaporated by heating (usually below 100° C.) under reduced pressure.

In certain embodiments, the reacting and drying are performed in one and the same step. In particular, microwave radiation provides the heat source to both form a Maillard reaction product in the slurry and to dehydrate the slurry, thereby providing a Maillard reaction product solid composition.

In an embodiment of the present invention, the method of forming a Maillard reaction product solid composition comprises the step of providing an aqueous slurry of a proteinogenic amino acid and a reducing sugar containing water in amounts up to 80 wt. %, in particular 10 to 70 wt. %, more particularly 10 to 50 wt. %, more particularly 15 to 40 wt. %, and more particularly still 10 to 30 wt. %, and applying microwave radiation thereto for a period of time sufficient to dehydrate the slurry and produce a Maillard reaction product solid composition. After dehydration of the slurry, the resulting Maillard reaction product solid composition can have a water content of 0.1 to 5 wt. % more particularly 0.5-5 wt. %, more particularly 1.0 to 4 wt. %, more particularly 1.0 to 3 wt. % and more particularly still 1.0 to 2 wt. %.

Aside from the water content of the slurry, the remaining mass of the slurry is comprised of precursor compounds, and any processing aids deemed necessary, such as proteins, or fragments of proteins, carbohydrates, fats and salts, and carriers.

Whereas fats and salts may be added to the slurry for the purpose of generating flavour, they may also aid in processing. For example, fats or oils ensure good heat dissipation throughout the slurry. The addition of salts can promote energy uptake into the slurry and increase the speed of heating.

In certain embodiments, the Maillard reaction product is in powder form and may be prepared by spray drying in a spray drying tower at an air inlet temperature of 100-180° C. and an air outlet temperature of 60-95° C., and optionally further drying and agglomerating at an air temperature between 25-60° C. to produce a free-flowing, dust-free powder of spray-dried particles.

In a particular embodiment, the slurry may be heated to 100° C. for a period of time to drive off most of the water by evaporation. The period of time will depend upon the water content of the slurry, but typically can range from about 1 to about 5 minutes.

Thereafter, the temperature of the slurry may be increased to 130, 140, 150 160 or 180° C. for a period of time both to complete formation of the Maillard reaction product, as well as to drive off any remaining water to complete the dehydration. A suitable time period may be from about 1 minute to about 100 minutes.

In certain embodiments, the Maillard reaction product is in powder form and may be prepared by incorporating at least one non-aqueous flavourant, such as beef flavour and/or umami flavour, into the aqueous slurry containing the Maillard reaction product and forming an emulsion or suspension, whereby the emulsion or suspension contains, on a non-aqueous basis, between about 50-80% by weight of the flavourant; and spray drying the emulsion or suspension in a spray drying tower at an air inlet temperature of 100-180° C. and an air outlet temperature of 60-95° C., and optionally further drying and agglomerating at an air temperature between 25-60° C. to produce a free-flowing, dust-free powder of spray-dried particles.

Other reaction types may be involved in forming the Maillard reaction product, for instance Schiff base formation, Strecker degradation and/or caramelization reactions. A reaction associated with certain Maillard reactions is Strecker degradation which involves oxidative deamination and decarboxylation of amino acids in the presence of dicarbonyls. Strecker degradation leads to the formation of aldehydes containing one fewer carbon atom than the original amino acids, and alpha-amino ketones precursors of pyrazines. Hydrogen sulfide, ammonia, and acetaldehyde are also formed from the breakdown of mercaptoiminol Strecker intermediate from cysteine specific reaction.

In certain embodiments, the Maillard reaction product is obtained by a non-enzymatic reaction of (1) one or more reducing sugars, and (2) one or more proteinogenic amino acids in the presence of heat. According to certain embodiments, the Maillard reaction product is formed by formation of N glycoside, as shown below.

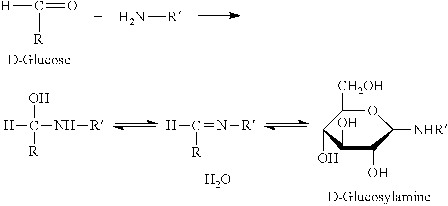

After formation of N glycoside, the immonium ion is formed and then isomerized, forming a compound called ketosamine, as shown below.

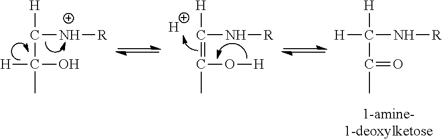

The ketosamine products then either dehydrate into reductones and dehydro reductones, or produce short chain hydrolytic fission products such as diacetyl, acetol or pyruvaldehyde which then undergo the Strecker degradation, as shown below.

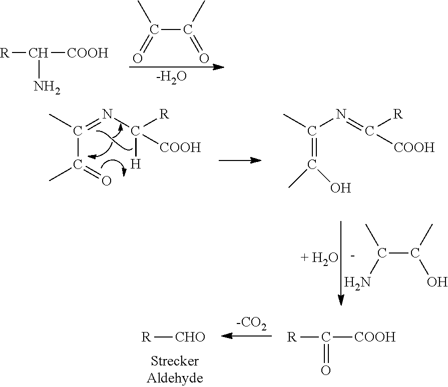

Reducing sugars are those that either have an aldehyde group or are capable of forming one in solution through isomerism. The aldehyde group allows the sugar to act as a reducing agent in the Maillard reaction. Cyclic hemiacetal forms of aldoses can open to reveal an aldehyde and certain ketoses can undergo tautomerization to become aldoses. Examples of reducing sugars include: glucose, fructose, dextrose, xylose, glyceraldehyde, galactose, lactose, arabinose, maltose, glucose polymers such as starch, hydrolyzed starch, and starch-derivatives like glucose syrup, maltodextrin, and dextrin. In certain embodiments, the one or more reducing sugars comprise a monosaccharide and/or a disaccharide. In certain embodiments, the one or more reducing sugars comprise dextrose and/or xylose. In certain embodiments, one or more reducing sugars are selected from the group consisting of xylose, glucose, mannose, galactose, rhamnose, and combinations thereof. In certain embodiments, two or more reducing sugars may be used to prepare the Maillard reaction product. In certain embodiments, three or more reducing sugars may be used to prepare the Maillard reaction product.

The proteinogenic amino acids are alanine (Ala), cysteine (Cys), aspartic acid (Asp), phenylalanine (Phe), glutamic acid (Glu), histidine (His), isoleucine (Ile), lysine (Lys), leucine (Leu), methionine (Met), asparagines (Asn), glutamine (Gin), arginine (Arg), serine (Ser), theronine (Thr), valine (Val), tryptophan (Trp), tyrosine (Tyr), proline (Pro) or glycine (Gly). In certain embodiments, two or more proteinogenic amino acids may be used to prepare the Maillard reaction product. In certain embodiments, three or more proteinogenic amino acids may be used to prepare the Maillard reaction product.

In certain embodiments, disclosed is a Maillard reaction product of at least two reducing sugars selected from dextrose and xylose and at least two proteinogenic amino acids selected from the group consisting of cysteine, alanine, leucine, proline and combinations thereof.

In addition to amino acids/amine sources (or their sources) and reducing sugars, the reaction mixture may contain other materials that can modify taste or flavour, including sulphur sources. Sulphur sources may be selected from the group consisting of hydrogen sulphide, cysteine, cystine, methionine, glutathione, thaimin, inorganic sulphides, organic thiols and sulphides, 2-mercaptoethanol derivatives, e.g. mercaptoacetaldehyde and/or its dimer 2,5-dihydroxy-1,4-dithiane, 5-hydroxy-3-mercaptopentanone, 3-mercaptopropan-1-ol, 4,5-substituted thiazoles, thiocarbonates, thioamides, 2-mercaptoalkoanoic acids/amides, mercaptoalkylamines, aminosulphides, S-acetylmercaptosuccinic acid, vegetable extracts, fermented vegetable juices, yeast extract, and autolysed yeast.

In certain embodiments, the ratio between proteinogenic amino acid and reducing sugar is within the range of 1:20 to 20:1. In certain embodiments, the ratio between proteinogenic amino acid and reducing sugar is within the range of 1:10 to 10:1. In certain embodiments, the ratio between proteinogenic amino acid and reducing sugar is within the range of 1:5 to 5:1. In certain embodiments, the ratio between proteinogenic amino acid and reducing sugar is within the range of 1:4 to 4:1. In certain embodiments, the ratio between proteinogenic amino acid and reducing sugar is within the range of 1:3 to 3:1. In certain embodiments, the ratio between proteinogenic amino acid and reducing sugar is within the range of 1:2 to 2:1. In certain embodiments, the ratio between proteinogenic amino acid and reducing sugar is approximately 1:1.

In certain embodiments, the Maillard reaction product is formed from a slurry containing 0 to about 15 wt % water; about 1 to about 10 wt % proteinogenic amino acid; about 5 to about 15 wt % reducing sugars; about 1 to about 10 wt % yeast extract; about 60 to about 80 wt % carrier; and about 5 to about 25 wt % non-aqueous flavorant.

The pH of the slurry can be adjusted in the range of 0.5 to 8, more particularly 2 to 8, and more particularly still 4 to 8. Any food grade acids and bases can be used. Examples of the acids include lactic acid, phosphoric acid, acetic acid, citric acid, malic acid, tartaric acid, oxalic acid, tannic acid, caffeotannic acid, benzoic acid, butyric acid, and combinations thereof. Examples of bases include sodium hydroxide, sodium carbonate, potassium bicarbonate, and sodium acetate.

The amount of Maillard reaction product added to the consumable is sufficient to modify the off-taste, and may be used, for example in an amount of about 0.005% to about 5% in the consumable. However, the skilled person will appreciate that the off-taste reducing effect or the taste-enhancing effect will depend upon a number of factors, for example the type of consumable, the qualitative and/or quantitative modification desired, the substance(s) imparting an off-taste, and the presence of other desirable or undesirable taste components, and that it may be possible for a flavorist to achieve the desirable effects working inside or outside this range.

In certain embodiments, the amount of Maillard reaction product added to the consumable is about 0.05% to about 3%, based on the total weight of the consumable. In certain embodiments, the amount of Maillard reaction product added to the consumable is about 0.05% to about 2%. In certain embodiments. In certain embodiments, the amount of Maillard reaction product added to the consumable is about 0.01% to about 2%. In certain embodiments. In certain embodiments, the amount of Maillard reaction product added to the consumable is about 0.10% to about 2%. In certain embodiments. In certain embodiments, the amount of Maillard reaction product added to the consumable is about 0.1% to about 1.5%. In certain embodiments. In certain embodiments, the amount of Maillard reaction product added to the consumable is about 0.5% to about 1.5%.

The Maillard reaction product can be prepared separate from a consumable or can be prepared during the preparation/production of a consumable. The Maillard reaction product of the present invention may represent a final taste modifying composition that may be blended with a food or beverage to modify or improve the flavour thereof. Alternatively, the Maillard reaction product may form only a part of a final taste modifying composition, and the Maillard reaction product can be mixed with other ingredients to form the final taste modifying composition. A skilled flavourist will be able to mix the Maillard reaction product of the present invention with other known ingredients employed in flavour compositions to develop a wide variety of taste modifying compositions to satisfy the requirements of the food and beverage industry.

Those other known ingredients useful in the taste modifying compositions may be added to the slurry before the formation of the Maillard reaction product, or they may be blended with a Maillard reaction product after it is formed, or both.

A taste modifying composition may comprise a Maillard reaction product as described herein; aroma volatiles and other flavour ingredients generally known in the art; and other synergists or enhancers, such as fats or fatty acids, or their sources, herbs, spices and the like; pH regulators; inorganic salts; taste masking agents, taste sensates; vitamins; dyes; colourants; pigments, and the like.

Other ingredients include aldehyde and ketone sources, including acetaldehyde, propanal, butanal, methylpropanal, C3 to C5 alkanals, HVP, alpha diketones and sources thereof, including butanedione, pentane-2,3-dione, pyruvaldehyde, pyruvic acid, glyceraldehyde, glyoxal, dihydroxyacetone, alpha-ketobutyric acid, heptane-3,4-dione-2,5-diacetate, HMFone, HDFone, and related derivatives, ascorbic acid, 5-ketogluconic acid, cyclotene, maltol, lactic acid, glycolic acid, malic acid, tartaric acid, and protein hydrolysates.

Examples of flavour enhancers and their sources include MSG, IMP, GMP, yeast extract, autolysed yeast, HVP, 2-furfuryl-thioinosine-5′-phsophate, 2-allyloxyinosine-5′-phosphate, 2-(lower alkoxy) inosine-5′-phosphate, 2-benzylthioinosine-5′-phosphate, 4-glucosylgluconic acid, and cyclotene.

Examples of pH regulators include mono-di- and tri-basic inorganic acids, such as HCl, sulphuric acid and phosphoric acid, organic acids, including succinic, citric, lactic, malic, tartaric, acetic and propanoic; amino acids, including valine, glycine and glutamic acids.

In certain embodiments, the taste-modifying composition comprises at least one non-aqueous flavorant. In certain embodiments, the taste-modifying composition comprises at least two different non-aqueous flavorants.

By “flavorant” it is meant a composition created by a flavorist using methods known to the skilled person that is a mixture of tastants, aroma compounds and sensates. In one embodiment, non-aqueous flavorants may include any one or more food-grade flavorants that do not substantially dissolve in water. The flavorant may be a liquid, gel, colloid, or particulate solid, for example, an oil, an extract, or the like. Examples of suitable flavorants include natural flavors, artificial flavors, spices, seasonings, and the like. Exemplary flavorants include synthetic flavor oils and flavoring aroma tics and/or oils, oleoresins, essences, and distillates, and a combination comprising at least one of the foregoing. Generally, any flavorant or food additive such as those described in “Chemicals Used in Food Processing”, Publication No 1274, pages 63-258, by the National Academy of Sciences, can be used. This publication is incorporated herein by reference.

The flavorant(s) present in the taste-modifying composition may impart a meat-like flavour and/or aroma profile. For example, the flavorant(s) present in the taste-modifying composition may impart a beef flavour, a chicken flavour, or an umami with liver flavour. In certain embodiments, the Maillard reaction product is present in amount less than the flavorant(s).

In certain embodiments, the taste-modifying composition consists of the Maillard reaction product. In certain embodiments, the taste-modifying composition consists essentially of the Maillard reaction product. In certain embodiments, the Maillard process flavor may be present in an amount of about 1% to about 99% based, on the total weight percent of the taste-modifying composition. In still other embodiments, the Maillard process flavor may be present in an amount of about 1% to about 50% based, on the total weight percent of the taste-modifying composition. In yet other embodiments, the Maillard process flavor may be present in an amount of about 15% to about 30% based, on the total weight percent of the taste-modifying composition.

In the preparation of the abovementioned compositions, there may be used all or any of the standard ingredients found in such products, used in art-recognized quantities. Examples of such ingredients include (but are by no means limited to) solvents and co-solvents; surfactants and emulsifiers; viscosity and rheology modifiers; thickening and gelling agents; preservative materials; pigments, dyestuffs and coloring matters; extenders, fillers and reinforcing agents; stabilizers against the detrimental effects of heat and light, bulking agents, flavoring and flavor-enhancing agents, acidulants, buffering agents and antioxidants.

The taste modifying composition may comprise a carrier material. As used herein, the phrase “carrier material” encompasses a bulk material that is practically neutral from a flavour point of view, i.e., it does not significantly alter the organoleptic properties of flavouring ingredients. The carrier may be a liquid or a solid. Suitable examples of liquid carriers include emulsifying systems, i.e., a solvent and a surfactant system, or a solvent commonly used in flavours. Suitable limiting examples of solvents commonly used in flavours, one can cite compounds such as propylene glycol, triacetine, triethyl citrate, benzylic alcohol, ethanol, vegetal oils or terpenes. Examples of solid carriers include absorbing gums or polymers or encapsulating materials. Examples of such materials, for example, may comprise wall-forming and plasticizing materials, such as mono, di- or trisaccharides, natural or modified starches, hydrocolloids, cellulose derivatives, polyvinyl acetates, polyvinylalcohols, proteins or pectins, and the like. In certain embodiments, the taste-modifying composition comprises top note, liquid, or powder blend flavors used in addition to the Maillard process flavor.

In certain embodiments, the taste-modifying composition is present in an amount of about 0.005% to about 5%, based on the total weight percent of the plant-based consumable. In certain embodiments, the taste-modifying composition is present in an amount of about 0.05% to about 4%, based on the total weight percent of the plant-based consumable. In certain embodiments, the taste-modifying composition is present in an amount of about 0.1% to about 3%, based on the total weight percent of the plant-based consumable. In certain embodiments, the taste-modifying composition is present in an amount of about 0.5% to about 2%, based on the total weight percent of the plant-based consumable.

In certain embodiments, the taste-modifying composition is free of animal-derived ingredients.

### Plant-Based Consumables

The phrase “Plant-based consumables” as used herein refers to preparations made from materials including, but not limited to, grain (rice, millet, maize, barley, wheat, oat, sorghum, rye, teff, triticale, amaranth, buckwheat, quinoa); legume or pulses, beans (such as soybean, mung beans, faba beans, lima beans, runner beans, kidney beans, navy beans, pinto beans, azuki beans, and the like), peas (such as green peas, yellow peas, pigeon peas, cowpea, and black-eyed peas and the like), sesame, garbanzo, potatoes, lentils, and lupins; fruits (such as fruits obtained from trees and shrubs of the genus Artocarpus); seed and oilseed (black mustard, India mustard, rapeseed, canola, safflower, sunflower seed, flax seed, hemp seed, poppy seed, pumpkin, chia, sesame); nuts (almond, walnut, Brazil, Macadamia, cashews, chestnuts, hazelnuts, pine, pecans, peanuts, pistachio and gingko); algal (kelp, wakame, spirulina, chlorella); mycoprotein and/or fungal protein.

The taste-modifying composition of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed.

The term “off-taste” as used herein refers to an unpleasant taste that develops over time after consumption of consumables. Off tastes may be formed as the result of one or more ingredients being added to, or present in, food products. An off-taste may be imparted by a non-animal derived protein, such as soy protein and pea protein. Off-tastes produced by non-animal derived proteins have been described as being grassy, beany, aldehyde-like, green, earthy, nutty and/or bitter. Non-animal derived proteins are present in vast categories of consumables including, but not limited to, savory products and sweet products. Off tastes may also be formed by processing methods, such as a sous-vide cooking method.

In certain embodiments, the at least one ingredient that imparts an off-taste is derived from fruit obtained from a species in the genus Artocarpus. In certain embodiments, the species is selected from the group consisting of breadfruit (Artocarpus altilis), jackfruit (Artocarpus heterophyllus), and combinations thereof Jackfruit, also known as the jack tree, is a species of tree in the fig, mulberry, and breadfruit family (Moraceae). Native to southern India, Sri Lanka, and the rain forests of Indonesia, Malaysia, and the Philippines, jackfruit has been used for hundreds of years in various Asian cuisines. It's the largest fruit that grows on a tree and can weigh up to 100 pounds.

On the outside, jackfruit can be green or yellow with hard, bumpy skin. The interior consists of edible fleshy bulbs. Jackfruit has a suitable texture for use in meat analog products due to its stringy, meaty texture similar to that of beef or pork. Jackfruit is also nutritionally dense due to its high fiber content and low amount of fat, calories and carbohydrates. However, jackfruit imparts one or more undesirable off-tastes described as bitter, grassy, astringent, earthy and/or chalky. In particular, the fleshy bulbs of jackfruit impart undesirable bitter off-tastes.

In other aspects, the present disclosure relates to meat analog products and methods for making meat analog products comprising the taste modifying compositions described herein. In certain embodiments, the taste modifying composition added to a meat analog in an amount sufficient to modify or mask an off-taste imparted by at least one ingredient in the meat analog. The phrase “meat analog” as used herein refers is a food product that approximates the aesthetic qualities and/or chemical characteristics of certain types of meat. The term “meat analog” also means a non-animal derived protein product that serves as an alternative or substitute for an animal meat product. According to certain illustrative embodiments, the meat analog is a plant-protein based product. The term meat analog includes those prepared with textured vegetable proteins (TVP), high moisture meat analogue (HMMA) and low moisture meat analogue (LMMA) products.

In certain embodiments, the meat analog product comprises jackfruit. In another aspect of the invention, a meat analog product comprising jackfruit contains an amount of the Maillard reaction product sufficient to modify or mask one or more off-tastes imparted by the jackfruit.

As demonstrated by the examples provided herein, it has surprisingly been found that unpleasant off-tastes imparted by one or more ingredients in plant-based consumables may be modified or the taste or taste perception may be improved by the inclusion of the Maillard reaction product in said consumables.

In another aspect of the present invention, there is provided a taste modifying composition for addition to a consumable or ingredient of a consumable which composition contains ingredients responsible for creating an off-taste, and the Maillard reaction product. The skilled person would appreciate that the precise amount of the Maillard reaction product in said consumable, for example in a meat analog product, would vary within wide limits, provided that the Maillard reaction product is admixed to a consumable in an amount sufficient to provide an off-taste masking or taste enhancing effect.

In a particular embodiment, provided is a meat analog product comprising soy protein and/or pea protein and the taste modifying composition. In a particular embodiment, provided is a meat analog product comprising at least a portion of fruit obtained from a species in the genus Artocarpus and the taste modifying composition. In a particular embodiment, provided is a meat analog product comprising at least a portion of fruit obtained from breadfruit (Artocarpus altilis) and/or jackfruit (Artocarpus heterophyllus) and the taste modifying composition. The meat analog comprising the taste modifying composition may be used, for example, to prepare a wide variety of dish types (e.g., grilled meat dish, fish dish, pasta dish, pizza dish, rice bowl dish, salad dish, etc.) and cuisine types (e.g., Italian, Indian, Tex-Mex, Chinese, etc.).

Also disclosed is a method for modifying the taste of a plant-based consumable comprising: adding a Maillard reaction product of a proteinogenic amino acid and a reducing sugar to the consumable in an amount of 0.005 wt. % to about 5 wt. %, which amount modifies or masks an off-taste imparted by at least one ingredient in the consumable. In certain embodiments, the plant-based consumable comprises soy protein and/or pea protein. In certain embodiments, the plant-based consumable comprises a fruit obtained from a species in the genus Artocarpus. In certain embodiments, the off-taste is a bitter off-taste, a grassy off-taste, a beany off-taste, a green off-taste, a chalky off-taste, an earthy off-taste, an astringent off-taste, a nutty off-taste, or combinations thereof.

### EXAMPLES

The following examples are given solely for the purpose of illustration and are not to be construed as limitations of the present invention, as many variations of the invention are possible without departing from the spirit and scope of the present disclosure.

### Preparation of a First Maillard Reaction Product

The following precursor ingredients were added to a pressure reactor containing 100 g of deionized water and sufficiently mixed until uniform: three proteinogenic amino acids comprising cysteine, alanine and L-proline (15 g total); reducing sugars comprising dextrose monohydrate and D-xylose (20.25 g total); and yeast extract powder and dark yeast extract (32.25 g total). In a subsequent step, partially hydrogenated sunflower oil of high oleic acid residue (541 g); non-aqueous beef fat flavor (28 g); carnosic acid (1.3 g); and mega fatty complex (1.3 g) were added to the pressure reactor and sufficiently mixed until uniform. The pressure reactor was then heated to 110° C. for 80 minutes and thereafter cooled to 63° C. The mixture was allowed to stand until separated and thereafter the top layer was removed and subjected to a separate drying step in a vacuum drying oven or by spray drying.

### Preparation of a Second Maillard Reaction Product

The following precursor ingredients were added to a pressure reactor containing 120 g of deionized water and sufficiently mixed until uniform: four proteinogenic amino acids comprising cysteine, alanine, leucine, and L-proline (15.8 g total); reducing sugars comprising dextrose monohydrate and D-xylose (20.4 g total); and yeast extract powder (34.4 g). In a subsequent step, partially hydrogenated sunflower oil of high oleic acid residue (590 g); non-aqueous chicken fat flavor (16 g); carnosic acid (1.4 g); and mega fatty complex (1.6 g) were added to the pressure reactor and sufficiently mixed until uniform. The pressure reactor was then heated to 110° C. for 80 minutes and thereafter cooled to 63° C. The mixture was allowed to stand until separated and thereafter the top layer was removed and subjected to a separate drying step in a vacuum drying oven or by spray drying.

### Sensory Evaluation in Soybean Meat Analog

The following examples were prepared:

TABLE 1

| | Example 1 | Example 2 | Example 3 |
|---|---|---|---|
| | (Control) | (Inventive) | (Inventive) |
| | wt. % | wt. % | wt. % |
| Soybean meat analog matrix | 97.5% | 97% | 97% |
| Umami with liver flavor | 1% | 1% | 1% |
| Beef (roasted) flavor | 1.5% | 1.5% | 1.5% |
| First Maillard | 0% | 0.5% | 0% |
| Reaction Product | | | |
| Second Maillard | 0% | 0% | 0.5% |
| Reaction Product | | | |

The soybean meat analogs according to Examples 1-3 were refrigerated overnight, and then cooked on a griddle to 71° C. Thereafter, a panel of four flavourists tasted Examples 1-3. All panelists determined that Example 2 (Inventive) and Example 3 (Inventive) exhibited a superior flavor profile, as compared to Example 1 (Control). In particular, the panelists indicated that Examples 2 and 3 (Inventive) exhibited reduced soy protein/beany notes as well as reduced bitterness, and concluded that these differences were “quite noticeable”. Based on these test results, it can be seen that Examples 2 and 3 (Inventive) exhibit a superior off-taste masking effect, as compared to Example 1 (Control).

Sensory Evaluation in Jackfruit (Artocarpus heterophyllus) Base

The following examples were prepared:

TABLE 2

| | Example 4 | Example 5 | Example 6 | Example 7 |
|---|---|---|---|---|
| | (Control) | (Control) | (Inventive) | (Inventive) |
| | wt. % | wt. % | wt. % | wt. % |
| Jackfruit base | 99% | 99% | 97% | 97.5% |
| Chicken umami | 1% | 0% | 1% | 0% |
| flavour | | | | |
| Beef (roasted) | 0% | 1% | 0% | 1% |
| flavour | | | | |
| Second Maillard | 0% | 0% | 2% | 1.5% |
| Reaction Product | | | | |

A jackfruit base was prepared utilizing a sous vide process at 200° F. for about 2 hours. In French, “sous-vide” means “under vacuum”. In this style of cooking, food is sealed in air-tight or substantially air-tight bags or the like and submersed in a water-bath having a tightly regulated temperature about that of a target finished cooking temperature for the food. Examples 4-7 were then prepared by adding the respective flavour and/or Second Maillard Reaction Product to the sous-vide prepared jackfruit base. Thereafter, a panel of flavourists tasted Examples 4-7 and determined that both Examples 6 and 7 (Inventive) exhibited a superior flavor profile, as compared to Examples 4 and 5 (Controls). In particular, the panelists indicated Examples 4 and 5 (Controls) exhibited negative taste profiles believed to be at least partially attributed to the sous-vide preparation method, whereas such negative taste attributes were significantly reduced or absent in Examples 6 and 7 (Inventive).

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A taste-modifying composition comprising a Maillard reaction product of a proteinogenic amino acid and a reducing sugar, which is effective in counteracting off-tastes imparted by at least one ingredient in a plant-based consumable when the Maillard reaction product is present in an amount of 0.005% to 5% in the consumable, based on the total weight of the consumable.

2. The taste-modifying composition of claim 1, wherein the at least one ingredient comprises a non-animal derived protein.

3. The taste-modifying composition of claim 2, wherein the non-animal derived protein is a pea protein, a soy protein, or combinations thereof.

4. The taste-modifying composition of claim 1, wherein the Maillard reaction product is present in an amount of 0.1% to 2% in the consumable.

5. The taste-modifying composition of claim 1, wherein the plant-based consumable comprises a fruit obtained from a species in the genus Artocarpus.

6. The taste-modifying composition of claim 5, wherein the species is selected from the group consisting of breadfruit (Artocarpus altilis), jackfruit (Artocarpus heterophyllus), cempedak (Artocarpus integer), and combinations thereof.

7. The taste-modifying composition of claim 1, wherein the off-taste is a bitter off-taste, a grassy off-taste, a beany off-taste, a green off-taste, a chalky off-taste, an earthy off-taste, an astringent off-taste, a nutty off-taste, or combinations thereof.

8. The taste-modifying composition of claim 1, wherein the composition is free of animal-derived ingredients.

9. The taste-modifying composition of claim 1 further comprising at least one non-aqueous flavorant.

10. The taste-modifying composition of claim 9, wherein the Maillard reaction product is present in amount less than the at least one flavorant.

11. The taste-modifying composition of claim 1, wherein the Maillard reaction product is present in an amount of 10% to 50%, based on the total weight percent of the taste-modifying composition.

12. The taste-modifying composition of claim 1, wherein the proteinogenic amino acid is selected from the group consisting of cysteine, alanine, leucine, proline, and combinations thereof; and the reducing sugar is selected from the group consisting of dextrose, xylose, ribose, glucose, fructose, aldose, rhamnose, lactose, maltose and combinations thereof.

13. The taste-modifying composition of claim 1 comprising the Maillard reaction product of at least two proteinogenic amino acids and at least two reducing sugars.

14. A plant-based consumable comprising at least one ingredient that imparts an off-taste to the consumable, and an off-taste masking and/or modifying agent comprising a Maillard reaction product of a proteinogenic amino acid and a reducing sugar, wherein the Maillard reaction product is present in the consumable in an amount of about 0.005% to about 5%, based on the total weight of the consumable.

15. The consumable of claim 14, wherein the at least one ingredient comprises a non-animal derived protein.

16. The consumable of claim 14, wherein the plant-based consumable comprises a fruit obtained from a species in the genus Artocarpus.

17. The consumable of claim 14, wherein the off-taste is a bitter off-taste, a grassy off-taste, a beany off-taste, a green off-taste, a chalky off-taste, an earthy off-taste, an astringent off-taste, a nutty off-taste, or combinations thereof.

18. A method for modifying the taste of a plant-based consumable comprising: adding a Maillard reaction product of a proteinogenic amino acid and a reducing sugar to the consumable in an amount of 0.005 wt. % to 5 wt. %, which amount modifies or masks an off-taste imparted by at least one ingredient in the consumable.

19. The method of claim 18, wherein the plant-based consumable comprises a fruit obtained from a species in the genus Artocarpus.

20. The method of claim 18, wherein the off-taste is a bitter off-taste, a grassy off-taste, a beany off-taste, a green off-taste, a chalky off-taste, an earthy off-taste, an astringent off-taste, a nutty off-taste, or combinations thereof.
